(19) United States
(12) Patent Application Publication
(10) Pub. No.: US 2009/0018914 A1
(43) Pub. Date: Jan. 15, 2009

(54) REMOTE MONITORING SYSTEM

(76) Inventor: Travis L. Smith, Golden Valley, MN (US)

Correspondence Address: PAULY, DEVRIES SMITH & DEFFNER, L.L.C., Plaza VII-Suite 3000, 45 South Seventh Street, MINNEAPOLIS, MN, 55402-1630, US

(21) Appl. No.: 12/169,929

(22) Filed: Jul. 9, 2008

Related U.S. Application Data
(60) Provisional application No. 60/948,488, filed on Jul. 9, 2007.

(51) Int. Cl. G06Q 30/00; G06F 17/00

(52) U.S. Cl. 705/14; 700/231; 340/870.01

(57) ABSTRACT

A remote monitoring system, for use in applications such as a vending machine, is disclosed. The remote monitoring system provides a user with a first code. The user transmits the first code to the entity that services the vending machine (or other installation). The first code not only provides the user with the opportunity to win a prize but also provides information about the status of the vending machine. The user then receives a second code that the user may enter into the machine to determine whether the user has won a prize but also to change the operation of the vending machine.

### PRIORITY

This application claims the benefit of U.S. Provisional Patent Application Ser. No. 60/948,488, entitled “VENDING MACHINE MOINITORING SYSTEM,” filed Jul. 9, 2007, the contents of which is herein incorporated by reference in its entirety.

### FIELD OF THE INVENTION

The invention relates generally to a system for monitoring status of a remote location, such as inventory of a vending machine.

### BACKGROUND OF THE INVENTION

Remote facilities and equipment, such as vending machines and similar stand-alone, unattended facilities, must be in good operating condition in order to perform their function. For example, they must be well stocked, must be accepting payment from customers, must not be jammed, etc. Because vending machines are generally not constantly monitored in real time in-person, it is possible to lose significant business opportunities when the vending machines are not working properly.

Vending machines enable products to be dispensed and services to be provided without needing a clerk to complete the transaction. While vending machines are generally very reliable, the vending machines periodically need to be serviced. The vending machines also need to be periodically restocked.

There are several options used for restocking and servicing vending machines. One option is to have a person physically visit the vending machine on a periodic basis. While historic sales records from the vending machine enable the service schedule to be fairly accurate such that the vending machine is refilled only when needed, this option is not able to account for unexpected periods where sales are greater than historic trends.

This option also does not have the ability to notify the service company of malfunctions in the vending machine. As such, the vending machine may be inoperable for a significant period of time between scheduled service visits. While it is possible to put contact information on the vending machine, users are not likely to report malfunctions in the vending machine.

A second option involves putting a communication device in the vending machine. The communication device may be a modem that transmits data via a conventional telephone network or it may transmit data via a wireless telephone network. It is also possible to transmit data regarding the vending machine via a wired or wireless internet connection.

While this option has the ability to provide the vending machine service company with real time data on the status of the vending machine, there are often significant costs associated with the hardware and communication services that may significantly impact the profit of the vending machine.

### SUMMARY OF THE INVENTION

An embodiment of the invention is directed to a remote monitoring system, for use in applications such as a vending machine. The remote monitoring system provides a user with a first code. The user transmits the first code to the entity that services the vending machine (or other installation). The first code not only provides the user with the opportunity to win a prize but also provides information about the status of the vending machine. The user then receives a second code that the user may enter into the machine to determine whether the user has won a prize but also to change the operation of the vending machine.

### BRIEF DESCRIPTION OF THE DRAWINGS

FIG. 1 is a schematic illustration of a remote monitoring system according to an embodiment of the invention.

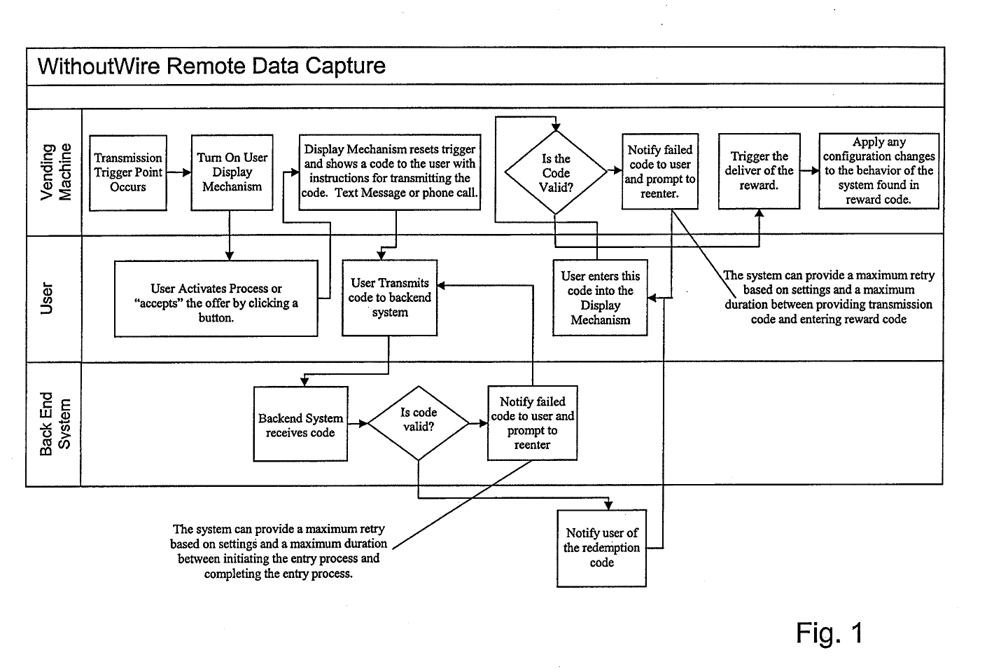

### DETAILED DESCRIPTION OF THE PREFERRED EMBODIMENTS

An embodiment of the invention is directed to a remote monitoring system. The remote monitoring system may be used in conjunction with vending machines that dispense a variety of products and services.

The remote monitoring system may be integrally fabricated with the vending machine to which it is to be used. Alternatively, the vending machine monitoring system may be attached to the vending machine after manufacture. To minimize the interference with the advertising value associated from the front of the vending machine and then permit the remote monitoring system to be attached to the vending machine with minimal damage to the vending machine, the remote monitoring system may be attached to a side of a door on the vending machine. The remote monitoring system may be attached to a sales monitoring system in the vending machine using a standard connector.

The remote monitoring system may have a variety of configurations. In its most basic configuration, the vending machine monitoring system may have a display for displaying a first code. The first code may be provided to the user in other forms such as audible, printed on a piece of paper or other media or printed on the product being dispensed from the vending machine. Instructions for the person to use the first code may be provided in conjunction with the first code.

The remote monitoring system may include a key pad on which the user may enter the second code into the remote monitoring system. The key pad may include numbers, letters or combination thereof. It is also possible to transmit the first and second codes between the remote monitoring system such as through a wireless communications protocol.

To further enhance the user's awareness of the remote monitoring system, the vending machine monitoring system may include lights and/or emit sounds.

When a person purchases a product or service from the vending machine, a first code is provided to the person. Alternatively, the remote monitoring system can display the first code to encourage the person to purchase a product or service from the vending machine.

The first code may include information about the status of the vending machine. For example, the first code could indicate whether the vending machine is operating correctly and whether one or more of the items in the vending machine need to be restocked. The first code may also include information on whether the person should receive a prize.

While the first code needs to be long enough to convey sufficient information about the status of the vending machine, the first code should be sufficiently short to facilitate the person accurately transmitting the first code to the vending machine service company.

As noted above, the first code may be provided on a display that is associated with the vending machine. The first code may also be printed out on a piece of paper or other medium. It is also possible for the first code to be transmitted to the person such as using text messaging or email.

To encourage the person to transmit the first code to the vending machine service company, the vending machine may include information about the prizes the person can win in response to transmitting the first code to the vending machine service company. The prizes may include free products or services from the vending machine. The prizes may also include larger prizes such as a vacation or vehicle e. It is also possible to encourage the person to transmit the code to the vending machine service company by awarding the person points that the person may collect and then redeem for products and/or services.

The person may transmit the code to the vending machine service company in a variety of mechanisms such as by sending a text message that includes the code to the vending machine service company. The code may also be transmitted to the vending machine service company via alternative mechanisms such as a telephone call, email message or web site. To increase the likelihood that the first code will be transmitted to the vending machine service company, the person should be encouraged to transmit the first code as soon as possible after it is received.

When the first code is received by the vending machine service company, the first code is initially analyzed to ensure that it is a valid code. If the first code is invalid, the person is provided with a message regarding the invalid nature of the code and the person is invited to resubmit the code.

Thereafter, the person receives a message from the vending machine service company. This message may be transmitted to the person using the same mechanism that was used to transmit the first code to the vending machine service company. Alternatively, the message may be transmitted to the person using a different mechanism than was used to transmit the first code to the vending machine service company.

The message may include an indication on whether the person has been awarded a prize. Alternatively, the message may include a second code that the person enters into the vending machine to determine if the person has been awarded a prize. The remote monitoring system analyzes the code to determine if it is valid. If the code is not valid, the vending machine monitoring system displays a message to this effect and the person is provided the opportunity to reenter the second code.

Similar to the first code that was provided by the vending machine, the second code may include data regarding the vending machine operation. Examples of codes would be to turn off the vending machine or to change the operating temperature in the vending machine.

In many instances, the person transmitting the first code to the vending machine service company or entering the second code into the vending machine would not be aware that the first code and the second code transmits data between the vending machine and vending machine service company regarding the operation of the vending machine.

It is contemplated that features disclosed in this application, as well as those described in the above applications incorporated by reference, can be mixed and matched to suit particular circumstances. Various other modifications and changes will be apparent to those of ordinary skill.

We claim:

1. A vending machine monitoring system comprising:
a display for displaying a first code;
a means for entering a second code into the vending machine;
wherein a user receives the first code from the vending machine monitoring system, and the second code from a separate monitoring location.

2. The vending machine monitoring system of claim 1, wherein the second code is entered into the vending machine monitoring system to identify a reward for the user.

3. The vending machine monitoring system of claim 1, wherein the vending machine monitoring system comprises a key pad on which the user may enter the second code into the remote monitoring system

4. The vending machine monitoring system of claim 3, wherein the key pad includes numbers, letters or combination thereof.

5. A method for monitoring a remote location, the method comprising:
providing a user with a first code received from equipment positioned at the remote location;
transmission by the user of the first code to a monitoring location;
receipt by the user of a second code from the monitoring location; and
communication of the second code by the user to the equipment positioned at the remote location.

6. The method for monitoring a remote location of claim 5, further comprising providing a reward to the user upon communication of the second code to the equipment positioned at the remote location.

7. The method of monitoring a remote location of claim 5, wherein the remote location comprises a vending machine.
